(19) United States
(12) Patent Application Publication
(10) Pub. No.: US 2004/0173716 A1
(43) Pub. Date: Sep. 9, 2004

(54) Mounting bracket for an electro-hydraulic control unit

(76) Inventors: Helmut Gegalski, Muhlheim-Karlich (DE); Burkard Bustgens, Neuwied (DE); Nicodemus Kappen, Merxheim (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/757,353

(22) Filed: Jan. 14, 2004

Related U.S. Application Data
(63) Continuation of application No. PCT/US02/23135, filed on Jul. 19, 2002.
(60) Provisional application No. 60/306,641, filed on Jul. 19, 2001.

(51) Int. Cl. F16M 11/00

(52) U.S. Cl. 248/200; 29/458

(57) ABSTRACT

A bracket for mounting an electro-hydraulic control unit upon a vehicle comprising a layer of resilient material disposed between a non-resilient inner support and a non-resilient outer shell.

### CROSS REFERENCE TO RELATED APPLICATION

This application is a continuation of co-pending International Patent Application No. PCT/US02/23 135 filed Jul. 19, 2002 claiming priority to U.S. Provisional Patent Application No. 60/306,641 filed Jul. 19, 2001. International Patent Application No. PCT/US02/23135 was published as WO 03/008245 on Jan. 30 2003 in English under PCT Article 21(2).

### BACKGROUND OF INVENTION

This invention relates in general to electro-hydraulic control units and in particular to a mounting bracket for attaching an electro-hydraulic control unit to a vehicle.

Many vehicles being currently produced by automotive manufacturers include automatic brake control systems that are integrated with their hydraulic brake systems. Such systems include Anti-lock Brake Systems (ABS) that prevent wheel lock-up during braking cycles, Vehicle Stability Control (VSC) systems that assist in preventing loss of directional control of a vehicle during vehicle maneuvers and Traction Control (TC) systems to prevent slippage of driven wheels on low mu surfaces, as encountered with icy road surfaces. Additionally, such systems also assist in preventing loss of directional control when the vehicle is operated upon normal or even high mu surfaces, as can occur during accident avoidance maneuvers.

An automatic brake control system typically includes an electro-hydraulic control unit that is integrated with the brake lines of the hydraulic brake system. Referring now to the drawings, there is shown in FIG. 1, a typical electro-hydraulic control unit 10 is shown for an automatic brake control system. The electro-hydraulic control unit typically includes an Electronic Control Unit (ECU) 12 which is mounted upon a hydraulic valve body 14. The hydraulic valve body 14 includes a plurality of ports that are connected to the vehicle hydraulic brake system.

The ECU 12 includes a microprocessor and control algorithm for operating the brake system. A plurality of solenoid valves are disposed within the hydraulic valve body 14. The solenoid valves can include normally open isolation valves and normally closed dump valves. The ECU 12 is connected to the solenoid valves and one or more wheel speed sensors (not shown). A pump 16 also is mounted upon the hydraulic valve body 14 to supply pressurized brake fluid to the brake control system. The pump is controlled by the ECU microprocessor.

During vehicle operation, the ECU microprocessor continuously receives speed signals from the wheel speed sensors. When the microprocessor senses an impending vehicle control problem, the brake control system is activated. The ECU microprocessor starts the pump to supply pressurized brake fluid and causes the solenoid valves to cyclically apply and relieve hydraulic pressure to the wheel brakes to correct the vehicle control problem.

The electro-hydraulic control unit 10 is typically mounted within the vehicle engine compartment or upon the vehicle chassis to allow connection of the vehicle's hydraulic brake lines to the hydraulic valve body 14. However, the available engine compartment or chassis surfaces may not be compatible with the needed orientation of the control unit 10 for connection to the brake lines. Accordingly, the electro-hydraulic control unit is 10 usually secured to a mounting bracket that is shaped to align the ports in the hydraulic valve body 14 with the ends of the vehicle's hydraulic brake lines. The mounting bracket is then attached to the engine compartment or chassis surface.

### SUMMARY OF INVENTION

This invention relates to a mounting bracket for attaching an electro-hydraulic control unit to a vehicle.

Typical prior art mounting brackets are fabricated from a sheet of steel. During fabrication, apertures are punched through the steel sheet. Stamping machines cut the sheet into bracket blanks and hydraulic presses bend the blanks into the desired bracket shape. However, being the resulting brackets may transmit vibrations between the vehicle and the electro-hydraulic control unit. For example, engine and other vehicle vibrations are transmitted through the bracket to the ECU where they may effect some of the components mounted therein. Additionally, noise and vibration generated by movement of the solenoid valve armatures, and by rotation of the motor armature and operation of the pump can be transferred from the electro-hydraulic control unit through the vehicle body to the passenger compartment, where they can be disturbing to the occupants. Accordingly, it would be desirable to provide a mounting bracket that reduces the transmission of vibrations and noise in both directions.

The present invention is directed toward a mounting device for a electro-hydraulic control unit that includes an outer supporting structure formed from a non-resilient material that is adapted to be attached to a vehicle. The device also includes a layer of resilient material disposed within and attached to the outer structure and adapted to be placed adjacent to the control unit whereby the resilient material absorbs vibrations. Additionally, the device may further an inner supporting structure formed from a non-resilient material that is attached to the surface of resilient layer that is opposite from the outer structure. The inner supporting structure adapted to be attached to the electro-hydraulic control unit.

In the preferred embodiment the mounting device is a bracket that is formed from a laminated material that has an inner layer of resilient material, such as rubber, is disposed between two outer layers of steel. Alternately, the bracket may include a single outer layer of steel that is lined by a resilient material, such as rubber.

The invention also contemplates a process for fabricating a mounting device for attaching a control unit to a vehicle that includes providing a sheet of laminated material having at least layer of resilient material bonded to at least one layer of non-resilient material. At least one aperture is punched through the sheet of laminated material. Flat blanks are stamped from the sheet of laminated material, with each of the blanks including at least one of the apertures formed previously. The blanks are then formed into brackets.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a perspective view of electro-hydraulic control unit for a vehicle brake system.

FIG. 2 illustrates a mounting bracket for the electro-hydraulic control unit shown in FIG. 1 that is in accordance with the invention.

FIG. 3 is a perspective view of an alternate embodiment of the mounting bracket shown in FIG. 2.

FIG. 3A is a sectional view of the mounting bracket shown in FIG. 3 taken along the line 3A-3A.

FIG. 4 is another alternate embodiment of the mounting bracket shown in FIG. 2.

FIG. 5 is another alternate embodiment of the mounting bracket shown in FIG. 2.

FIG. 6 is another alternate embodiment of the mounting bracket shown in FIG. 2.

FIG. 7 is a flow chart for a method for fabrication of a mounting bracket.

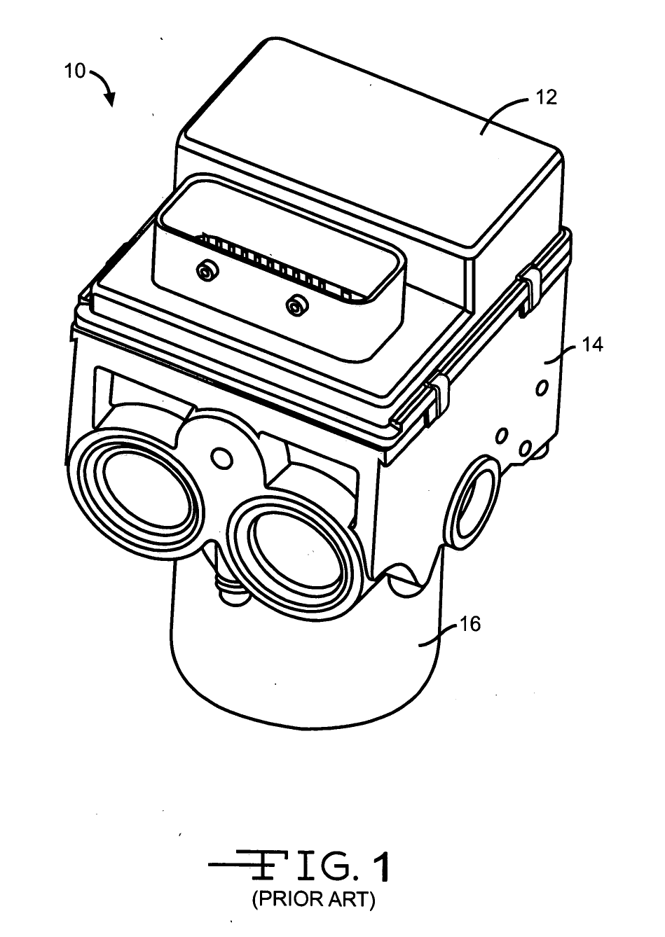

### DETAILED DESCRIPTION

Referring again to the drawings, there is illustrated in FIG. 2, an improved mounting bracket 20 in accordance with the invention. As shown in FIG. 2, the bracket 20 has a generally U-shape that cradles an electro-hydraulic control unit 10. The bracket 20 is formed from a laminated material that includes layers of material having extremely different acoustical impedances, such as, for example a metal and a polymer. The polymer absorbs acoustic noise and vibrations while the metal provides stiffness to the bracket 20 to provide a desired high first natural vibration frequency to the combined bracket and electro-hydrualic control unit assembly. A higher natural frequency of the assembly provides more effective filtering of the natural frequency and its harmonics.

As illustrated in FIG. 2, the mounting bracket 20 includes a intermediate layer 22 formed from a resilient material, such as a polymer, disposed between an outer shell 24 formed from a non-resilient material, such as a metal, and an inner support 26 that also is formed from a non-resilient material. In the preferred embodiment, the resilient polymer layer 22 is formed from rubber and is 0.1 mm thick while the outer shell 24 and inner support 26 are formed from a steel sheet that is 0.7 mm thick. It will be appreciated that the invention also may be practiced with the bracket components 22, 24 and 26 formed from other materials. Similarly, the invention also may be practiced with other thicknesses of the bracket components 22, 24 and 26. The intermediate layer 22 is bonded to the outer shell 24 and the inner support 26 by a conventional method, such as an adhesive bonding.

It is contemplated that the bracket 20 is formed from a sheet of laminated material conventional processes. For example, apertures can be punched through the sheet and stamping machines utilized to cut the sheet into bracket blanks. The blanks can then be bent over forms into the desired bracket shape with hydraulic presses. Alternately, sheet steel is formed by conventional processes into the outer shell and inner support components. A layer of resilient material is attached to the one of the outer shell and inner support and the other of the outer shell and inner support is then attached to form the bracket.

The inner support 26 has a plurality of apertures 28 formed therethrough. The apertures receive threaded fasteners 30, three of which are shown in FIG. 2 to secure the electro-hydraulic control unit 10 to the bracket 20. Because the fasteners 30 attach only the inner support 26 to the control unit 10, the intermediate resilient layer 22 completely isolates the inner support 26 from the outer shell 24. As shown in FIG. 2, the inner support 26 is shaped to reduce the contact between the control unit 10 and the bracket 20. Thus, spaces 31 are formed between the control unit 10 and the bracket 20. The spaces 31 reduce transmission of vibration and noise between the control unit 10 and the bracket 20. The spaces 31 also accommodate the shape of the control unit surface, allowing use of a stampings having simpler shapes for the outer shell 24 and the inner support 26.

The outer shell 24 has a plurality of mounting tabs 32 that extend therefrom. Apertures (not shown) are formed through the mounting tabs 32 and receive threaded fasteners for attaching the assembled mounting bracket 20 and electro-hydraulic control unit 10 to the vehicle. Alternately, mounting extensions (not shown) may be formed upon the outer shell 24 that extend beyond the control unit 10. Apertures formed through the mounting extensions receive threaded fasteners that attach the assembly to the vehicle. Where necessary, openings 34 (one shown) are provided through the outer shell 24 and the resilient layer 22 to provide access to the threaded fasteners 30 that secure the control unit 10 to the bracket 20.

The inventors have found that the improved bracket 20 provides sufficient damping to attenuate both the transmission of vehicle vibrational noise to the ECU 12 and the transmission of acoustic and vibrational noise from the electro-hydraulic control unit 10 to the vehicle passenger compartment.

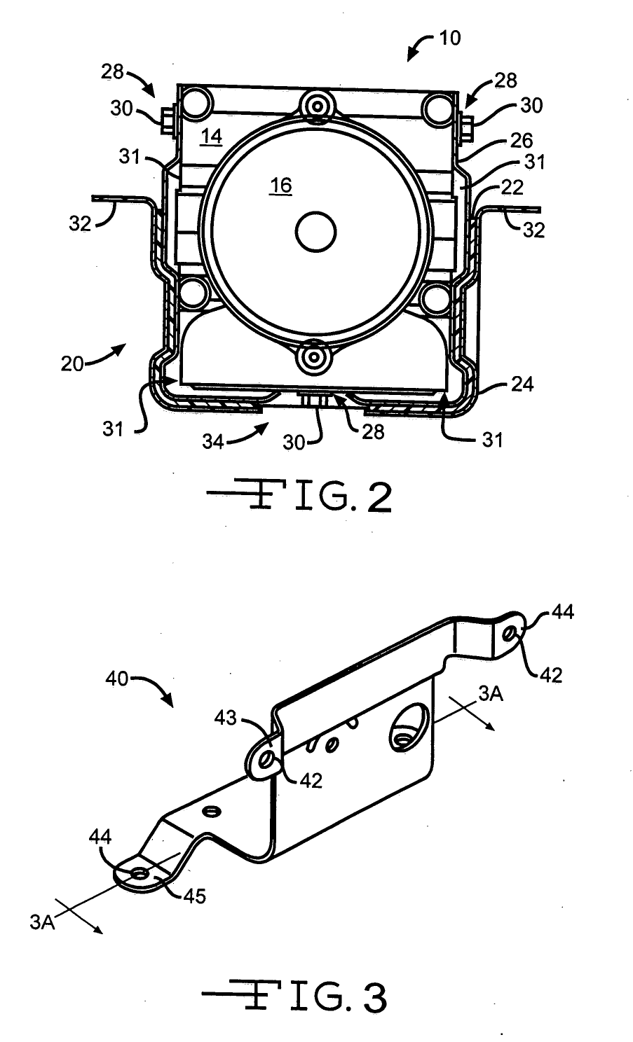

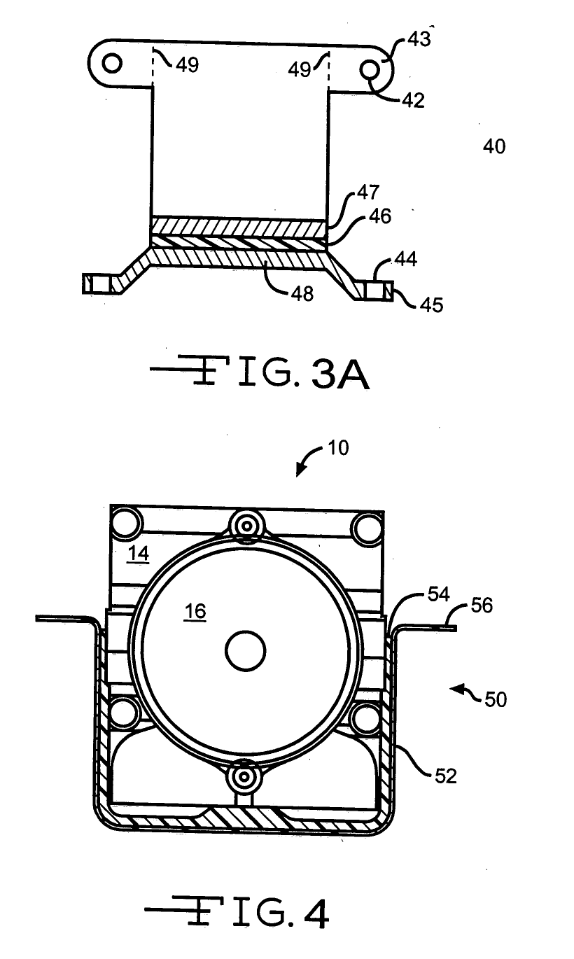

While the preferred embodiment of the invention has been illustrated and described as a generally U-shaped bracket 20 that cradles the control unit 10, it will be appreciated that the invention also can be practiced with brackets having different shapes. An alternate embodiment of the invention is illustrated generally at 40 in FIG. 3. The bracket 40 has a generally L-shape and is stamped from a laminated material comprising an intermediate layer formed from a resilient material, such as a polymer, that is disposed between two outer supporting layers formed from a non-resilient material, such as a metal. In the preferred embodiment, the resilient material is rubber while the non-resilient material is steel. For the bracket 40, the electro-hydraulic control unit would be attached to the bracket by a pair of threaded fasteners that pass through an upper pair of apertures 42 formed through mounting tabs 43 that extend from an upper portion of the bracket. The bracket 40 would be attached to the vehicle by a second pair of threaded fasteners that pass through a lower pair of apertures 44 (one shown) formed though mounting tabs 48 that extend from a lower portion of the bracket.

A sectional view of the preferred embodiment of the bracket 40 is shown in FIG. 3A and illustrates the laminated structure thereof that includes a layer of resilient material 46 sandwiched between an upper and lower outer layers of non-resilient material, 47 and 48, respectively. As illustrated in FIG. 3A, only one of the outer layers extend from the bracket 40 to form the tabs 43 and 45. The dashed lines labeled 49 in the upper portion of FIG. 3A indicated the edge of the resilient layer 46 and the lower outer layer 48. Thus, the upper tabs 43 are formed only in the upper layer 47 while the lower tabs 45 are formed only in the lower layer 48 to maintain the isolation of noise and vibration.

Alternately, the bracket 40 may be stamped from a sheet of laminated material with the mounting tabs also formed from laminated material (not shown). While being easier, and thereby less expensive, to fabricate, such a bracket would not provide the same amount of isolation since the fasteners would contact both non-resilient layers. Accordingly, the insulative effect for noise and vibration would be reduced.

Another embodiment of the mounting bracket is shown at 50 in FIG. 4. While the bracket 50 has a generally U-shape that cradles the electro-hydrualic control unit 10, similar to the bracket 20 illustrated in FIG. 2, it differs in having a only an outer shell 52 formed from a non-resilient material, such as a metal, that is lined by a layer of a resilient material 54, such as a polymer. As in the brackets described above, in the preferred embodiment, the resilient material is rubber while the non-resilient material is steel. Also in the preferred embodiment, the resilient layer 54 is thicker that the resilient layer 22 shown in FIG. 2. A mounting flange 56 or mounting tabs (not shown) is formed along the edges of the bracket 50. A plurality of apertures (not shown) are formed through the mounting flange 56 and receive threaded fasteners for attaching the bracket 50 to the vehicle.

In the preferred embodiment, the bracket 50 is permanently attached to the control unit 10 by a conventional process, such as with an adhesive bond. Thus, the resilient layer 54 provides complete isolation between the bracket 50 and the control unit 10. Alternately, two or more apertures (not shown) can be formed through the bracket 50 to permit a removable attachment of the bracket 50 to the control unit 10 with threaded fasteners. However, use of threaded fasteners in such a manner may reduce the noise and vibration damping efficiency of the resilient polymer material.

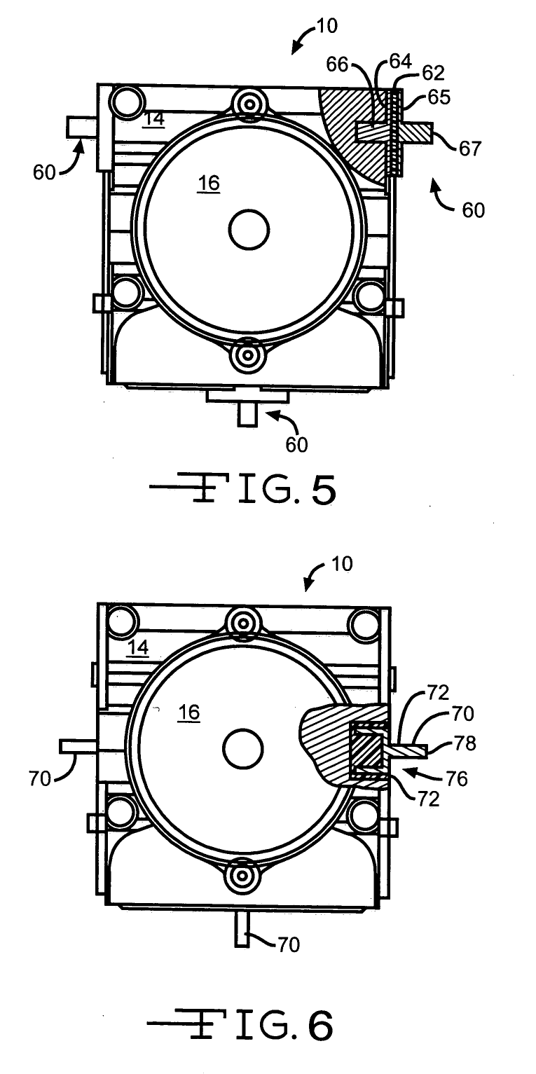

Another alternate embodiment of the invention is illustrated in FIG. 5 where a plurality of mounting devices 60 are used instead of a single bracket. As best seen in the upper right corner of FIG. 5 each of the mounting devices 60 includes an intermediate layer of resilient polymer material 62 that is disposed between an inner mount 64 and an outer mount 65. In the preferred embodiment, the inner mount 64 has generally cylindrical portion 66 that extends into a corresponding bore formed in the electo-hydraulic control unit 10. The outer mount 65 has a similar generally cylindrical portion 67 that extends away form the device and is used to secure the assembly to the vehicle.

In the preferred embodiment, the extended portions 66 and 67 of the inner and outer mounts 64 and 65 are threaded. The inner mount extended portion 66 is screwed into the corresponding bore formed in the control valve body 14, which also is threaded. Each of the extended portions 67 of the outer mounts 65 is then received by an aperture formed in a surface of the vehicle engine compartment and secured with a nut. Alternately, a threaded bore can be formed in one or both of the inner and outer mounts (not shown). The bore in the inner mount would receive a threaded fastener that first passed through an aperture formed through a tab that extends from the control unit 10. Similarly the bore in the outer mount would receive a threaded fastener that passed through an aperture formed through a tab that extends from a surface within the vehicle's engine compartment to secure the assembly upon the vehicle.

While the preferred embodiment of the mounting device 60 has been illustrated with three such devices securing the control unit 10 in FIG. 5, it will be appreciated that the control unit 10 also can be secured to the vehicle with more or less of the mounting devices 60.

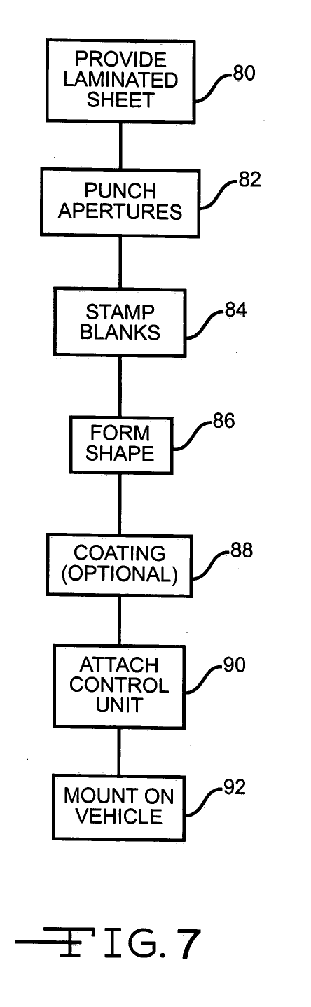

An alternate embodiment of the mounting device illustrated in FIG. 5 is shown at 70 in FIG. 6. Each of the mounting devices 70 comprises an outer mount 72 that extends into a bock 74 formed from a resilient material 74, such as a polymer. The resilient block 74 is disposed in a corresponding bore 76 formed in the hydraulic valve block. In the preferred embodiment, rubber is used for the resilient block 74 and the block 74 is permanently secured within the valve block bore 76 by a conventional process, such as, for example, adhesive bonding. Also, in the preferred embodiment, the outer mount 72 is formed from a non-resilient material, such as steel, and includes a threaded shaft 78 that extends in an outward direction. The shaft 78 extends into a corresponding mounting aperture formed in the vehicle engine compartment and is secured with a nut. Alternately, a threaded bore (not shown) can be formed in the shaft 78. For the alternate embodiment, the threaded bore in the outer mount shaft would receive a threaded fastener to secure the assembly within the vehicle engine compartment.

While the preferred embodiment has been described and illustrated for a mounting bracket to attach an electro-hydraulic control valve to a vehicle, it will be appreciated that the invention also may be used for other purposes. For example, the bracket also can be utilized to attach an electronic control unit only (not shown) to a vehicle. Such an application would arise with an electric brake system where there is no hydraulic valve body or when the electronic control unit is located separate from the hydraulic valve body.

The present invention also contemplates a process for fabricating a bracket. The process is illustrated by the flow chart in FIG. 7. In functional block 80 a laminated sheet of a resilient material bonded to at least one layer of a non-resilient material is provided. Alternately, a laminated sheet comprising an intermediate layer of resilient material sandwiched between two layers of non-resilient material is provided. In functional block 82, apertures are punched through the laminated sheet. Flat bracket blanks are stamped from the laminated sheet in functional block 84. The blanks are formed into the brackets in functional block 86 by a conventional process, such as pressing over forms. The resulting brackets are coated or painted 86 for rust protection in functional block 88; however, this step is optional. The control unit is attached in functional block 90 and the control unit and bracket assembly is installed upon a vehicle in functional block 92.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A mounting device for a securing a control unit to a vehicle comprising:
an outer supporting structure formed from a non-resilient material that is adapted to be attached to a vehicle; and
a layer of resilient material disposed within and attached to said outer structure, said resilient material being adapted to be placed adjacent to the control unit whereby said resilient material absorbs noise and vibrations.

2. The mounting device according to claim 1 further including an inner supporting structure formed from a non-resilient material that is attached to a surface of said layer of resilient material that is opposite from said outer supporting structure, said inner structure being adapted to be attached to the control unit.

3. The mounting device according to claim 2 wherein the resilient material is a polymer that is attached to said outer and inner supporting structures.

4. The mounting device according to claim 3 wherein said polymer is rubber and said outer and inner supporting structures are formed from steel.

5. The mounting device according to claim 4 wherein said layer of resilient material is adhesively bonded to said outer and inner supporting structures.

6. The mounting device according to claim 4 wherein said inner and outer supporting structures are generally U-shaped and form a bracket that is adapted to secure the control unit to a vehicle.

7. The mounting device according to claim 6 wherein the control unit is an electronic control unit that is attached to a hydraulic valve body to form an electro-hydraulic control unit and further wherein said inner and outer supporting structures are generally U-shaped and form a bracket that is adapted to secure said electro-hydraulic control unit to a vehicle

8. The mounting device according to claim 1 wherein the resilient material is a polymer that is attached to said outer supporting structure.

9. The mounting device according to claim 8 wherein said polymer is rubber and said outer supporting structure is formed from steel.

10. The mounting device according to claim 9 wherein said layer of resilient material is adhesively bonded to said outer supporting structure.

11. The mounting device according to claim 9 wherein said outer supporting structure is generally U-shaped and forms a bracket that is adapted to secure the electro-hydraulic control unit to a vehicle.

12. The mounting device according to claim 1 wherein said resilient material is adapted to be received within a corresponding bore formed in the electro-hydraulic control unit.

13. The mounting device according to claim 12 wherein said outer structure includes a threaded portion that extends from the mounting bracket and is adapted to secure the device to a vehicle.

14. The mounting device according to claim 12 wherein said outer structure includes a threaded bore formed therein that receives a threaded fastener that is adapted to secure the device to a vehicle.

15. The mounting device according to claim 1 further including an inner structure that has a threaded portion adapted to be received in a corresponding threaded bore formed in an electro-hydraulic control unit.

16. A control unit for a vehicle comprising:
an outer supporting structure formed from a non-resilient material that is adapted to be attached to a vehicle;
a layer of resilient material disposed within and attached to said outer structure; and
an electronic control unit for controlling a vehicle system disposed within said layer of resilient material whereby said resilient material absorbs noise and vibrations.

17. The control unit according to claim 16 further including an inner supporting structure formed from a non-resilient material that is attached to a surface of said layer of resilient material that is opposite from said outer supporting structure, said inner structure being attached to said electronic control unit.

18. The control unit according to claim 17 further including a hydraulic valve body attached to said electronic control unit to form a electro-hydraulic control unit, the electro-hydraulic control unit being attached to said inner supporting structure.

19. A process for fabricating a mounting device for attaching a control unit to a vehicle comprising the steps of:
(a) providing a sheet of laminated material having at least one layer of resilient material bonded to at least one layer of non-resilient material;
(b) punching at least one aperture through the sheet of laminated material;
(c) stamping at least one flat blank from the sheet of laminated material with the stamped blank including at least one of the apertures formed in step (b);
(d) forming the blank into a bracket.

20. The process according to claim 19 further including mounting a control unit on the bracket.

21. The process according to claim 20 further including attaching the combined control unit and bracket to a vehicle.

22. The process according to claim 20 further including, subsequent to step (d) and before mounting the control unit on the bracket, applying a coating to the bracket to inhibit formation of rust.
